(19) United States
(12) Patent Application Publication
(10) Pub. No.: US 2022/0406043 A1
(43) Pub. Date: Dec. 22, 2022

(54) MACHINE LEARNING MODEL FOR ACCURATE CROP COUNT

(71) Applicant: SEETREE SYSTEMS LTD., Tel Aviv (IL)

(72) Inventors: Ori SHACHAR, Nes Harim (IL); Dori REICHMANN, Jerusalem (IL); Yuval YABLONEK, Kibbutz Maoz Haim (IL); Guy SALTON-MORGENSTERN, Mevaseret-Zion (IL); Amir HAREL, Revadim (IL)

(21) Appl. No.: 17/777,271

(22) PCT Filed: Nov. 17, 2020
(86) PCT No.: PCT/IL2020/051190

§ 371 Date: May 16, 2022

Related U.S. Application Data
(60) Provisional application No. 62/936,525, filed on Nov. 17, 2019.

(51) Int. Cl. G06V 10/774; G06V 20/10; G06V 20/68; G06T 7/73

(52) U.S. Cl. CPC G06V 10/7747; G06V 20/188; G06V 20/68; G06T 7/73; G06T 2207/30242; G06T 2207/30188

(57) ABSTRACT

A method comprising: receiving a set of images associated with each of a plurality of plants in a plantation; estimating, with respect to each of the plants, based, at least in part, on the set of images associated with the plant, the following data: (i) a count of fruits detected in the plant, and (ii) one or more features associated with the plant; at a training stage, training a machine learning model on a training set comprising, with respect to a subset of the plurality of plants: (iii) the data, and (iv) labels indicating an actual a number of fruits in each of the plants in the subset; and at an inference stage, applying the trained machine learning model to the data associated with the rest of the plurality of plants, to predict a number of fruits in each of the rest of the plurality of plants.

### CROSS-REFERENCE TO RELATED APPLICATIONS

This application is a National Phase of PCT Patent Application No. PCT/IL2020/051190 having International filing date of Nov. 17, 2020, which claims the benefit of priority from U.S. Provisional Patent Application No. 62/936,525, filed on Nov. 17, 2019. The contents of which are all incorporated by reference as if fully set forth herein in their entirety.

### BACKGROUND

This invention relates to the field of computer image processing.

Precision agriculture describes a management technique based on tree and crop data measurements in the field, using, for example, computerized imaging technique. The correlation of data with its position in the field over time is used to make farm management decisions that can maximize overall returns. Data collection can include information about main areas such as farm environment, soil, plants, or the final crops. Much value may be gained by providing more specific and accurate data on accurate yield prediction of crop yields, to enable staging of equipment and resources for harvest, packaging and storage as well as the capability to accurately price crops.

The foregoing examples of the related art and limitations related therewith are intended to be illustrative and not exclusive. Other limitations of the related art will become apparent to those of skill in the art upon a reading of the specification and a study of the figures.

### SUMMARY OF THE INVENTION

The following embodiments and aspects thereof are described and illustrated in conjunction with systems, tools and methods which are meant to be exemplary and illustrative, not limiting in scope.

There is provided, in an embodiment, a system comprising at least one hardware processor; and a non-transitory computer-readable storage medium having stored thereon program instructions, the program instructions executable by the at least one hardware processor to: receive at least one image associated with each of a plurality of plants comprising a plantation, estimating, with respect to each of the plants, based, at least in part, on the at least one image associated with the plant, data comprising: (i) a count of fruits detected in the plant, and (ii) one or more features associated with the plant, at a training stage, training a machine learning model on a training set comprising, with respect to a subset of the plurality of plants: (iii) the data, and (iv) labels indicating an actual a number of fruits in each of the plants in the subset, and at an inference stage, applying the trained machine learning model to the one or more images associated with at least one of the plurality of plants not included in the subset, to predict a number of fruits in the at least some plant.

There is also provided, in an embodiment, a method comprising: receiving at least one image associated with each of a plurality of plants comprising a plantation; estimating, with respect to each of the plants, based, at least in part, on the at least one image associated with the plant, data comprising: (i) a count of fruits detected in the plant, and (ii) one or more features associated with the plant; at a training stage, training a machine learning model on a training set comprising, with respect to a subset of the plurality of plants: (iii) the data, and (iv) labels indicating an actual a number of fruits in each of the plants in the subset; and at an inference stage, applying the trained machine learning model to the one or more images associated with at least one of the plurality of plants not included in the subset, to predict a number of fruits in the at least some plant.

There is further provided, in an embodiment, a computer program product comprising a non-transitory computer-readable storage medium having program instructions embodied therewith, the program instructions executable by at least one hardware processor to: receive at least one image associated with each of a plurality of plants comprising a plantation; estimating, with respect to each of the plants, based, at least in part, on the at least one image associated with the plant, data comprising: (i) a count of fruits detected in the plant, and (ii) one or more features associated with the plant; at a training stage, training a machine learning model on a training set comprising, with respect to a subset of the plurality of plants: (iii) the data, and (iv) labels indicating an actual a number of fruits in each of the plants in the subset; and at an inference stage, applying the trained machine learning model to the one or more images associated with at least one of the plurality of plants not included in the subset, to predict a number of fruits in the at least some plant.

In some embodiments, the count of fruits detected in each of the plants is achieved by applying an object detection algorithm to the at least one image associated with the plant, to detect fruits in the at least one image.

In some embodiments, the detecting comprises: (i) estimating a spatial dimension of a canopy of each of the plants within a reference 3D coordinate system; (ii) determining a spatial location of each of the detected fruits within the reference 3D coordinate system; and (iii) associating each of the detected fruits with one of the plants, based, at least in part, on the estimating and the determining.

In some embodiments, the reference 3D coordinate system is plant-specific.

In some embodiments, the detecting further comprises eliminating dually-counted fruits based, at least in part, on the determining of the spatial location of each of the detected fruits.

In some embodiments, with respect to each of the plants, the at least one image comprises a plurality of images, and wherein each of the plurality of images is obtained from a specified viewpoint in relation to the plant.

In some embodiments, the one or more features comprise, with respect to each of the plants, at least some of: spatial location of fruit in the plants, fruit distribution in the plant, plant dimensions, plant type, and plant variety.

In addition to the exemplary aspects and embodiments described above, further aspects and embodiments will become apparent by reference to the figures and by study of the following detailed description.

### BRIEF DESCRIPTION OF THE FIGURES

The present invention will be understood and appreciated more comprehensively from the following detailed description taken in conjunction with the appended drawings in which:

FIG. 1 shows a schematic illustration of an exemplary system for automated counting of crops in trees, according to an embodiment;

FIG. 2 is a flowchart illustrating the functional steps in a process for automated counting of crops in trees, according to an embodiment;

FIG. 3 shows an orchard imaging scheme, according to an embodiment;

FIG. 4A shows a canopy dimension delineation step, according to an embodiment;

FIG. 4B shows a dual count removal step, according to an embodiment; and

FIGS. 5A-5B show the results of the predictive model as compared to ground-truth manual count, according to an embodiment.

### DETAILED DESCRIPTION

Disclosed are a system, method, and computer program product for accurate automated counting of crops, e.g., fruit, in trees in the field, using computer vision techniques.

As noted above, crop yield estimation is an important task in the management of a variety of agricultural crops, including fruit orchards, such as apples. Fruit crops, such as apples, citrus fruits, grapes, and others, are composed of the plant parts (leaves, branches, and stems), as well as the fruit, which may be present in various stages of maturity. Current industry practice to estimate the number of fruit in a commercial orchard block involves manually counting the average number of fruit on several trees and multiplying by the total tree count. The amount of fruit on each tree can be highly variable, and so, the total average estimates are often inaccurate. Additionally, fruit counts should ideally be assessed at several times during crop growth, which today is too labor intensive, costly and inefficient for farmers. After harvest, larger commercial operators can use machinery in the packing-shed to weigh and count the fruit, which provides size or weight distributions from individual orchard blocks retrospectively, as long as the book-keeping to map fruit-bins to blocks was done correctly during the harvest. Both methods give data about entire orchard blocks and cannot be used to map the distribution of yield spatially within a block, which is necessary for precision agriculture management per tree.

In some embodiments, the present disclosure employs machine vision techniques to facilitate counting fruit on each tree in an orchard, in a manner that is efficient at the whole-orchard scale. This in turn enables more frequent and more accurate fruit mapping, to allow commercial orchards to adopt precision agriculture techniques to address the needs of each tree and to plan ahead for harvest labor, packing-shed operations and marketing.

In some embodiments, the present disclosure provides for accurate automated counting of a wide range of crop plants, e.g., trees, shrubs, vegetation, and other crops. In some embodiments, the present method is effective across a wide range of planting layouts of crops in, e.g., orchards, groves, plantations, fields, and woods. In some embodiments, the present disclosure is effective even when dealing with typical layouts of commercial orchards, which may include a highly dense plating pattern with minimal spacing and canopy overlap between plants.

In some embodiments, the present disclosure may, therefore, provide of accurate count of visible whole or partial fruit, based on imaging the plant from multiple viewpoints and/or view angles, while avoiding double counting of individual fruits, correctly associating fruit with individual plants, as well as measure fruit dimensions and distribution within the plant.

There are many challenges present when attempting to count fruit automatically. First, any counting technique must count as many of the visible fruit as possible. Second, some of the fruit may be only partly visible, occluded, and/or visible under varying lighting and shade conditions. These challenges may require imaging a plant from multiple angles and/or viewpoints to try to capture all fruits. However, imaging a plant from multiple angles present the risk of double-counting individual fruit. In addition, different tree types have varying distributions of crops throughout the tree, e.g., inside the canopy vs. outside the canopy, and top vs. bottom, which requires adapting the counting technique to the tree type. In some crop types and/or planting schemes, trees may be closely-placed and/or have canopies which overlap one another. This further presents the challenge of correctly associating fruit with tree.

Accordingly, in some embodiments, the present disclosure provides for automated fruit crop yield estimation on a per-tree basis, using one or more remote sensing means, e.g., imaging devices and/or radar-based devices. In some embodiments, the present disclosure provides accurate automated estimation of the number, size, distribution the correct number of crop items (e.g., fruit) that are associated with a specific single plant (e.g., tree).

For this purpose, the present disclosure may provide for a combination of one or more techniques for plant detection, location, segmentation, and/or delineation using aerial and/or ground-based imaging means.

In some embodiments, the preset disclosure first provides for an accurate location detection with respect to individual plants (e.g., trees) within a commercial planting environment (e.g., an orchard). For this purpose, the present disclosure may provide for accurate detection and location with respect to a reference coordinate system, of a trunk of each plant in the orchard. For example, the present disclosure may combine one or more techniques, such as plant detection using, e.g., aerial, satellite, and/or any other above-ground imaging. In some embodiments, plant detection may comprise detection and segmentation of individual plant canopies using aerial imaging.

In some embodiments, aerial plant detection may lead to plant identification using, e.g., an indexing and/or another identification scheme.

In some embodiments, aerial plant detection may be supplemented with ground-based imaging and location detection of plant trunks within the reference coordinate system.

In some embodiments, a combined approach of aerial imaging and ground-based trunk location may yield (i) an accurate location of each plant within the reference coordinate system, (ii) a known identity of the plant, and (iii) an accurate delineation of a canopy of the plant.

In some embodiments, the present disclosure then provides for an accurate count of fruits and/or other crops in each plant, based on computer vision and/or machine learning techniques. For example, the present disclosure may apply a trained classifier to detect individual fruit in each plant. In some embodiments, the fruit detection process may also provide for determining a spatial location of the fruit within a single reference 3-dimensional (3D) coordinate system.

In some embodiments, the known spatial location of each fruit may then be cross-referenced with the known canopy delineation of each plant, to determine an association between fruit and plant.

In some embodiments, the present disclosure may further be configured to remove double-counted fruit, as a possible result of imaging and classifying fruit from more than one angle and/or viewpoint of the plant.

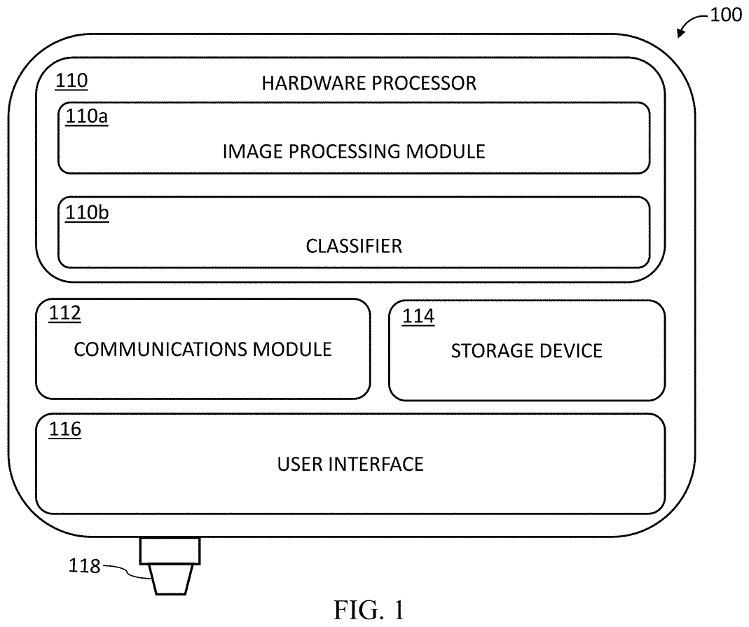

Reference is now made to FIG. 1, which is a schematic illustration of an exemplary system 100, according to the present invention. The various components of system 100 may be implemented in hardware, software or a combination of both hardware and software. system 100 as described herein is only an exemplary embodiment of the present invention, and in practice may have more or fewer components than shown, may combine two or more of the components, or a may have a different configuration or arrangement of the components. In some embodiments, pats or all of system 100 may be stationary, mounted on board a moving vehicle, and/or airborne.

In some embodiments, system 100 may include a hardware processor 110, an image processing module 110a, a classifier 110b, a communications module 112, a memory storage device 114, a user interface 116, an imaging device 118. System 100 may store in a non-volatile memory thereof, such as storage device 114, software instructions or components configured to operate a processing unit (also “hardware processor,” “CPU,” or simply “processor), such as hardware processor 110. In some embodiments, the software components may include an operating system, including various software components and/or drivers for controlling and managing general system tasks (e.g., memory management, storage device control, power management, etc.) and facilitating communication between various hardware and software components.

In some embodiments, imaging device 118 may include one or more imaging devices, for example, which may input one or more data streams and/or multiple frames to enable identification of at least one object. In other embodiments, imaging device 118 may include an interface to an external imaging device, e.g., which may input one or more data streams and/or multiple frames to system 100 via imaging device 118.

In some embodiments, non-transient computer-readable storage device 114 (which may include one or more computer readable storage mediums) may be used for storing, retrieving, comparing, and/or annotating captured frames. Image frames may be stored on storage device 114 based on one or more attributes, or tags, such as a time stamp, a user-entered label, or the result of an applied image processing method indicating the association of the frames, to name a few.

The software instructions and/or components operating hardware processor 110 may include instructions for receiving and analyzing multiple frames captured by imaging device 118. For example, image processing module 110a may receive one or more image frames and/or image streams from imaging device 118 or from any other interior and/or external device, and apply one or more image processing algorithms thereto.

In some embodiments, hardware processor 110 may be configured to perform and/or to trigger, cause, control and/or instruct system 100 to perform one or more functionalities, operations, procedures, and/or communications, to generate and/or communicate one or more messages and/or transmissions, and/or to control hardware processor 110, image processing module 110a, classifier 110b, communications module 112, memory storage device 114, user interface 116, imaging device 118, and/or any other component of system 100.

In some embodiments, image processing module 110a may include one or more algorithms configured to perform such image processing tasks with respect to images captured by imaging device 118 or by any other interior and/or external device, using any suitable image processing or feature extraction technique. The images received by the image processing module 110a may vary in resolution, frame rate, format, and protocol. The processing module 110a may apply processing algorithms to the images, e.g., alone or in combination.

In some embodiments, classifier 110b is a machine learning classifier which may be configured to be trained on a training set comprising a plurality of images and labels, and to classify each pixel in an image according into specified classes according to one or more classification techniques and/or algorithms.

In some embodiments, communications module 112 may connect system 100 to a network, such as the Internet, a local area network, a wide area network and/or a wireless network. Communications module 112 facilitates communications with other external information sources and/or devices, e.g., external imaging devices, over one or more external ports, and also includes various software components for handling data received by system 100.

In some embodiments, user interface 116 may include circuitry and/or logic configured to interface between system 100 and a user of system 100. user interface 116 may be implemented by any wired and/or wireless link, e.g., using any suitable, Physical Layer (PHY) components and/or protocols.

In some embodiments, system 100 may further comprise a GPS module which may include a Global Navigation Satellite System, e.g., which may include a GPS, a GLObal NAvigation Satellite System (GLONASS), a Galileo satellite navigation system, and/or any other satellite navigation system configured to determine positioning information based on satellite signals. In some embodiments, GPS module may include an interface to receive positioning information from a control unit and/or from any other external system.

In some embodiments, hardware processor 110 may be configured to cause image processing module 110a to receive a source image and/or a target image, for example, each depicting a dense recurring pattern including an array of objects arranged in close proximity to one another, e.g., as described below. In some embodiments, hardware processor 110 may be configured to cause classifier 110b to obtain a classification, e.g., a pixel-level classification, of the source image and/or the target image into one of at least two classes.

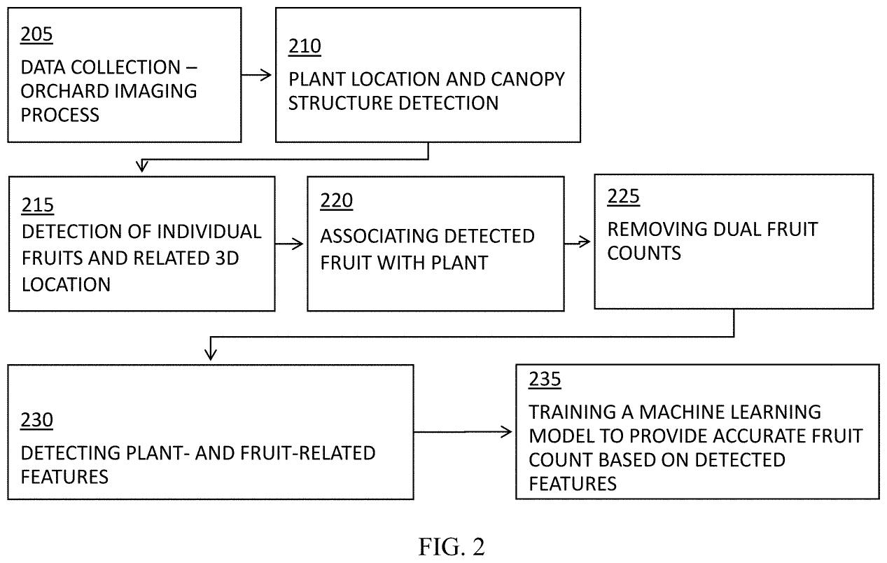

FIG. 2 is a flowchart illustrating the functional steps in an automated counting of crops, e.g., fruit, in trees in the field, using computer vision techniques.

In some embodiments, at step 205, the present disclosure provides for collecting image and/or related data with respect to individual plants in a commercial planting environment. In some embodiments, these data may yield (i) an accurate location of each plant within a single reference coordinate system, (ii) a known identity of the plant, and (iii) an accurate delineation of a canopy of the plant.

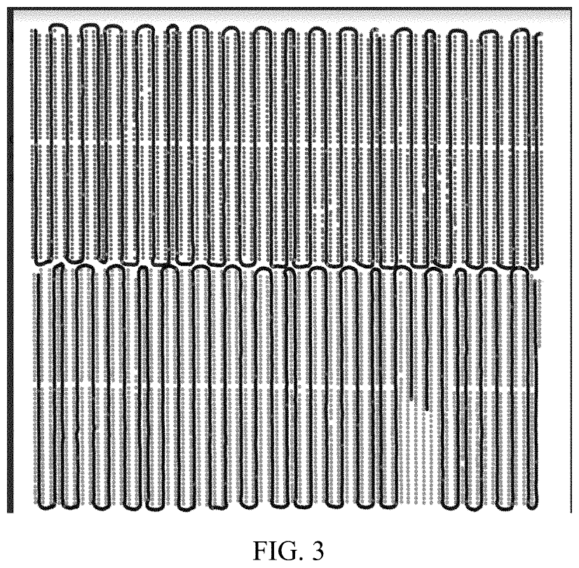

In some embodiments, data collecting may be performed through a system, e.g., system 100, with respect to a commercial planting environment, e.g., a fruit orchard. For example, a roving data collection vehicle may comprise one or more imaging devices configured to perform ground-based imaging of individual plants within an orchard from various angles and/or viewpoints. In some embodiments, a data collection vehicle may comprise, e.g., one or more imaging devices, light sources, GPS sensors, logging servers, etc. In some embodiments, imaging devices used by the present system, e.g., imaging device 118, may comprise one or more of mono cameras, stereo cameras, multifocal cameras, surround view cameras, night vision, IR camera, UV cameras, depth sensors, millimeter wave radar, LiDAR, and/or ultrasonic devices. In some embodiments, two or more of these devices can be used in combination with one another, to achieve higher accuracy, precision, repeatability, and/or to allow for a wider field of view. In some embodiments, as shown in FIG. 3, a data collection vehicle may image individual plants within an orchard from multiple angles and/or viewpoints and/or flanks of the plants, by traveling along rows of the orchard, e.g., in a back and forth, zig-zag fashion.

In some embodiments, at step 210, data collected in step 205 may be used to determine at least one of: (i) trunk location within a single reference coordinate system, and/or (ii) canopy structure, shape, dimensions, and/or position in relation to plant trunk. In some embodiments, such data may be cross-referenced with aerial and/or other images of the plants, to accurately delineate canopy dimensions, perimeter, edges, boundaries, and/or borders.

In some embodiments, a data collection vehicle comprising system 100 may comprise facility for, e.g., providing controlled lighting as well as adjustment of imaging sensitivity and exposure, moving speed, and/or other data collection parameters, to account for varying data collection condition, including time of day, season, lighting conditions, weather conditions, plant and fruit type, orchard layout, operator skill, and the like.

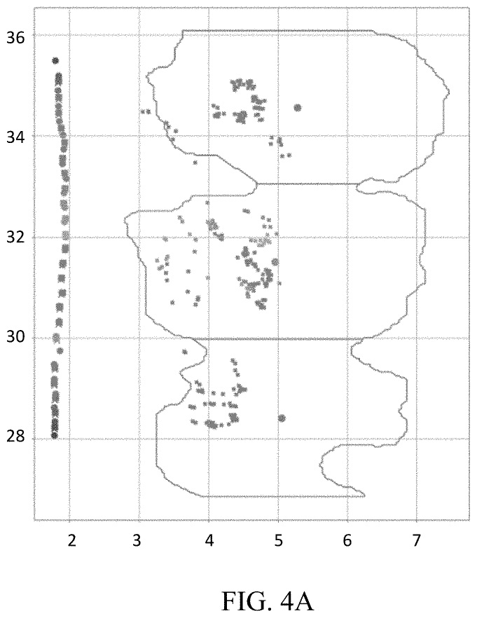

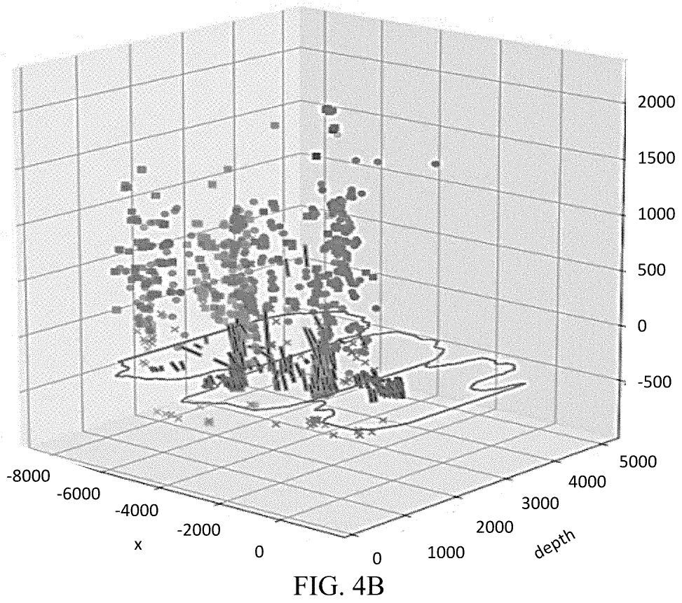

With reference to FIG. 4A, in some embodiments, at the conclusion of step 210, the present disclosure may provide for (i) an accurate location of each plant within a single reference coordinate system, (ii) a known identity of the plant, and (iii) an accurate delineation of a canopy structure, shape, dimensions, and/or position in relation to a trunk of the plant.

In some embodiments, at step 215, an object detection stage is performed to identify each individual fruit within a canopy of each plant in the orchard. In some embodiments, fruit detection may provide a count of individual fruit on each plant. In some embodiments, the present disclosure may apply a trained machine learning classifier to perform pixel-level classification of objects in acquired images, to detect individual fruits within each canopy. For example, the trained classifier may provide for a segmentation, a bounding box, and/or a similar detection technique. supplies a rectangle or a contour around the fruit.

In some embodiments, at step 215 may further include a 3D spatial location detection with respect to each detected fruit, within a single reference coordinate system. In some embodiments, 3D location detection may be achieved using, e.g., information from a depth sensor.

In some embodiments, a classifier may further be is used to determine whether a detected fruit is partially occluded. For every fully-visible detected fruit, the present disclosure then calculated fruit size and/or dimensions in 3D.

In some embodiments, at step 220, fruit 3D spatial location detection may be cross-referenced with canopy structure, shape, dimensions, and/or position determined in step 210, to associate fruit with plant, and to provide a count of individual fruit within each plant. For example, trunk location and/or canopy structure determined in previous steps may be sued to estimate a spatial relation between a detected individual and, e.g., neighboring plants and plant canopies. A set of rules may then be sued to decide if the detected fruit belongs to either one of the neighboring plants.

With reference to FIG. 4B, in some embodiments, at step 225, the present disclosure may provide for removing dual fruit counts, which may be the result of imaging the same individual fruit from multiple points of view. In some embodiments, dual count removal is based, at least in part, on aligning all detected fruit within a single reference 3D coordinate system. In some embodiments, this may be achieved using, e.g., visual odometry and/or ego-motion techniques, wherein two detected objects (e.g., fruit) having the same or nearly identical 3D spatial location may be deemed to be a double count of an individual fruit.

In some embodiments, at step 230, the present disclosure may provide for a feature extraction step. For example, such features as fruit location relative to each plant, fruit distribution relative to each plant, plant-related features such as plant dimensions, plant type and variety, as well as additional and/or other fruit and plant-related features.

In some embodiments, at step 235, a machine learning model may be trained to provide an accurate prediction of fruit number in plants of an orchard, based, at least in part, on training set comprising:
(i) Fruit numbers detected in a subset of the plants,
(ii) Features obtained with respect to each plant in the subset, and
(iii) Ground-truth fruit numbers obtained through manual counting with respect to each plant in the subset.

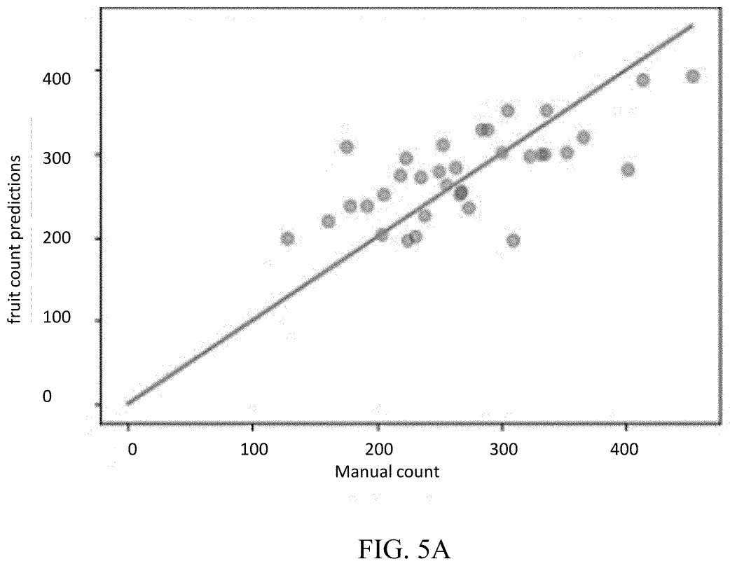

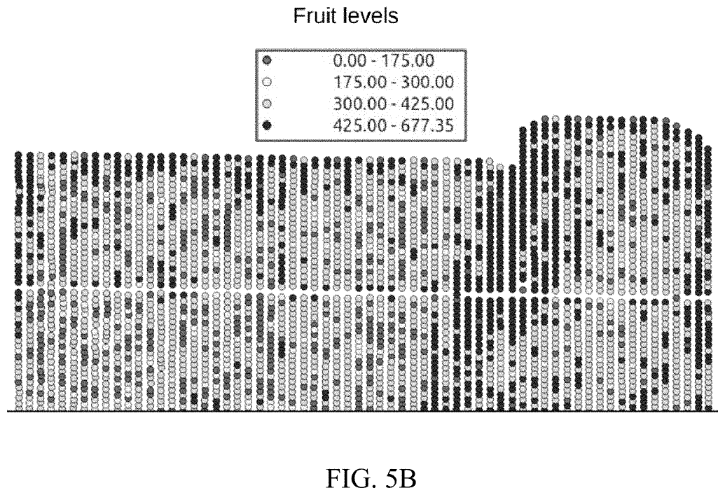

The trained machine learning model may then be applied to data collected with respect to all plants in the orchard, to reach an optimal prediction with respect to the number of fruits per plant for each plant. FIGS. 5A-5B shows the results of the predictive model as compared to ground-truth manual count.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Rather, the computer readable storage medium is a non-transient (i.e., not-volatile) medium.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of modified purpose computer, special purpose computer, a general computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A system comprising:
at least one hardware processor; and
a non-transitory computer-readable storage medium having stored thereon program instructions, the program instructions executable by the at least one hardware processor to:
receive at least one image associated with each of a plurality of plants in a plantation,
estimating, with respect to each of said plurality of plants, based, at least in part, on said at least one image associated with said plant, data comprising:
(i) a count of fruits detected in said plant, and
(ii) one or more features associated with said plant,
at a training stage, training a machine learning model on a training set comprising, with respect to each plant in a selected subset of said plurality of plants:
(iii) said data, and
(iv) labels indicating an actual a number of fruits in each of said plants in said subset, and
at an inference stage, applying said trained machine learning model to said one or more images associated with one or more of said plurality of plants not included in said subset, to predict a number of fruits in said one or more plants.

2. The system of claim 1, wherein said count of fruits detected in each of said plants is achieved by applying an object detection algorithm to said at least one image associated with said plant, to detect fruits in said at least one image.

3. The system of claim 1, wherein said detecting comprises:
(i) estimating a spatial dimension of a canopy of each of said plants within a reference 3D coordinate system;
(ii) determining a spatial location of each of said detected fruits within said reference 3D coordinate system; and
(iii) associating each of said detected fruits with one of said plants, based, at least in part, on said estimating and said determining.

4. The system of claim 3, wherein said reference 3D coordinate system is plant-specific.

5. The system of claim 3, wherein said detecting further comprises eliminating dually-counted fruits based, at least in part, on said determining of said spatial location of each of said detected fruits in relation to said spatial dimension of said canopy of each of said plants.

6. The system of claim 1, wherein, with respect to each of said plants, said at least one image comprises a plurality of images, and wherein each of said plurality of images is obtained from a specified viewpoint in relation to said plant.

7. The system of claim 1, wherein said one or more features comprise, with respect to each of said plants, at least some of: spatial location of fruit in said plants, fruit distribution in said plant, plant dimensions, plant type, and plant variety.

8. A method comprising:
receiving at least one image associated with each of a plurality of plants in a plantation;
estimating, with respect to each of said plurality of plants, based, at least in part, on said at least one image associated with said plant, data comprising:
(i) a count of fruits detected in said plant, and
(ii) one or more features associated with said plant;
at a training stage, training a machine learning model on a training set comprising, with respect to each plant in a selected subset of said plurality of plants:
(iii) said data, and
(iv) labels indicating an actual a number of fruits in each of said plants in said subset; and
at an inference stage, applying said trained machine learning model to said one or more images associated with one or more of said plurality of plants not included in said subset, to predict a number of fruits in said one or more plants.

9. The method of claim 8, wherein said count of fruits detected in each of said plants is achieved by applying an object detection algorithm to said at least one image associated with said plant, to detect fruits in said at least one image.

10. The method of claim 8, wherein said detecting comprises:
(i) estimating a spatial dimension of a canopy of each of said plants within a reference 3D coordinate system;
(ii) determining a spatial location of each of said detected fruits within said reference 3D coordinate system; and
(iii) associating each of said detected fruits with one of said plants, based, at least in part, on said estimating and said determining.

11. The method of claim 10, wherein said reference 3D coordinate system is plant-specific.

12. The method of claim 10, wherein said detecting further comprises eliminating dually-counted fruits based, at least in part, on said determining of said spatial location of each of said detected fruits in relation to said spatial dimension of said canopy of each of said plants.

13. The method of claim 8, wherein, with respect to each of said plants, said at least one image comprises a plurality of images, and wherein each of said plurality of images is obtained from a specified viewpoint in relation to said plant.

14. The method of claim 8, wherein said one or more features comprise, with respect to each of said plants, at least some of: spatial location of fruit in said plants, fruit distribution in said plant, plant dimensions, plant type, and plant variety.

15. A computer program product comprising a non-transitory computer-readable storage medium having program instructions embodied therewith, the program instructions executable by at least one hardware processor to:
receive at least one image associated with each of a plurality of plants in a plantation;
estimating, with respect to each of said plurality of plants, based, at least in part, on said at least one image associated with said plant, data comprising:
(i) a count of fruits detected in said plant, and
(ii) one or more features associated with said plant;
at a training stage, training a machine learning model on a training set comprising, with respect to each plant in a selected subset of said plurality of plants:
(iii) said data, and
(iv) labels indicating an actual a number of fruits in each of said plants in said subset; and
at an inference stage, applying said trained machine learning model to said one or more images associated with one or more of said plurality of plants not included in said subset, to predict a number of fruits in said one or more plants.

16. The computer program product of claim 15, wherein said count of fruits detected in each of said plants is achieved by applying an object detection algorithm to said at least one image associated with said plant, to detect fruits in said at least one image.

17. The computer program product of claim 15, wherein said detecting comprises:
(i) estimating a spatial dimension of a canopy of each of said plants within a reference 3D coordinate system;
(ii) determining a spatial location of each of said detected fruits within said reference 3D coordinate system; and
(iii) associating each of said detected fruits with one of said plants, based, at least in part, on said estimating and said determining.

18. (canceled)

19. The computer program product of claim 17, wherein said detecting further comprises eliminating dually-counted fruits based, at least in part, on said determining of said spatial location of each of said detected fruits in relation to said spatial dimension of said canopy of each of said plants.

20. The computer program product of claim 15, wherein, with respect to each of said plants, said at least one image comprises a plurality of images, and wherein each of said plurality of images is obtained from a specified viewpoint in relation to said plant.

21. The computer program product of claim 15, wherein said one or more features comprise, with respect to each of said plants, at least some of: spatial location of fruit in said plants, fruit distribution in said plant, plant dimensions, plant type, and plant variety.
